(19) United States
(12) Patent Application Publication
(10) Pub. No.: US 2020/0332889 A1
(43) Pub. Date: Oct. 22, 2020

(54) ROTARY ACTUATOR

(71) Applicant: DENSO CORPORATION, Kariya-city (JP)

(72) Inventors: Takanori MAKINO, Kariya-city (JP); Hiroyuki KADO, Kariya-city (JP); Mikine KUME, Kariya-city (JP)

(21) Appl. No.: 16/841,808

(22) Filed: Apr. 7, 2020

(30) Foreign Application Priority Data
Apr. 16, 2019 (JP) 2019-077926

(51) Int. Cl. F16H 61/32; G01D 5/245; H02K 11/215; H02K 7/116; H02K 7/00

(52) U.S. Cl. CPC F16H 61/32; G01D 5/245; H02K 7/006; H02K 7/116; H02K 11/215

(57) ABSTRACT

An actuator includes an electric motor; a plurality of electronic components, which control an operation of the electric motor; a control circuit board, to which the plurality of electronic components are installed; position sensors, which are installed to the control circuit board; and a plurality of displacement limiting supports. The motor position sensors are configured to sense a rotational position of a rotor and a motor shaft of the electric motor. One of the displacement limiting supports is installed along an entire of a perimeter around the motor position sensors. Another one of the displacement limiting supports is installed at a part of a perimeter around a corresponding specific one of the electronic components. The displacement limiting supports support the control circuit board such that the displacement limiting supports limit displacement of the control circuit board.

### CROSS REFERENCE TO RELATED APPLICATIONS

This application is based on and incorporates herein by reference Japanese Patent Application No. 2019-077926 filed on Apr. 16, 2019.

### TECHNICAL FIELD

The present disclosure relates to a rotary actuator.

### BACKGROUND

For example, there has been proposed a rotary actuator that reduces a speed of rotation outputted from an electric motor through a speed reducer mechanism and outputs the rotation of reduced speed from an output shaft. A magnet is fixed to an end portion of a motor shaft to sense a rotational position of the motor shaft, and a position sensor is installed at a control circuit board to sense a magnetic flux generated from the magnet. The operation of the electric motor is controlled based on an output of the position sensor. An outer peripheral portion of the control circuit board is fixed to a case. A sensing accuracy of the position sensor is largely influenced by a gap between the magnet and the position sensor.

### SUMMARY

This section provides a general summary of the disclosure, and is not a comprehensive disclosure of its full scope or all of its features.

According to the present disclosure, there is provided a rotary actuator. The rotary actuator includes a plurality of displacement limiting supports that support a control circuit board such that the plurality of displacement limiting supports limit displacement of the control circuit board.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram showing a shift-by-wire system that includes a rotary actuator according to a first embodiment.

FIG. 2 is a diagram for describing a shift range change mechanism shown in

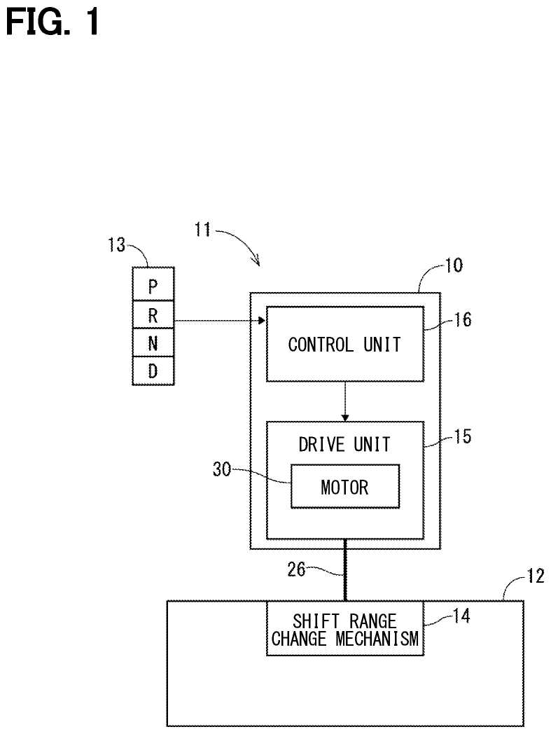

FIG. 1.

FIG. 3 is a cross-sectional view of the rotary actuator according to the first embodiment.

FIG. 4 is a view of a control unit taken along line IV-IV in FIG. 3.

FIG. 5 is a view of the control unit taken along line V-V in FIG. 3.

FIG. 6 is a view of a control unit of a rotary actuator according to a second embodiment and corresponding to FIG. 4 of the first embodiment.

FIG. 7 is a view of the control unit of the rotary actuator according to the second embodiment and corresponding to FIG. 5 of the first embodiment.

FIG. 8 is a cross-sectional view of a rotary actuator according to a third embodiment.

FIG. 9 is a view of a control unit of a rotary actuator according to another embodiment and corresponding to FIG. 4 of the first embodiment.

FIG. 10 is a view of the control unit of the rotary actuator according to the other embodiment and corresponding to FIG. 5 of the first embodiment.

FIG. 11 is a view of a control unit of a rotary actuator according to a further embodiment and corresponding to FIG. 4 of the first embodiment.

### DETAILED DESCRIPTION

For example, there has been proposed a rotary actuator that reduces a speed of rotation outputted from an electric motor through a speed reducer mechanism and outputs the rotation of reduced speed from an output shaft. A magnet is fixed to an end portion of a motor shaft to sense a rotational position of the motor shaft, and a position sensor is installed at a control circuit board to sense a magnetic flux generated from the magnet. The operation of the electric motor is controlled based on an output of the position sensor. An outer peripheral portion of the control circuit board is fixed to a case.

A sensing accuracy of the position sensor is largely influenced by a gap between the magnet and the position sensor. With respect to this point, in the above-described actuator, portions of the control circuit board, at which components are installed, are largely displaced by, for example, vibrations. Thereby, the gap described above is changed to cause a deterioration in the sensing accuracy of the position sensor. Furthermore, when the control circuit board is displaced by, for example, the vibrations, the durability of the electronic components and/or the solder for fixing the electronic components placed at the control circuit board may possibly be deteriorated.

According to the present disclosure, there is provided a rotary actuator for a shift-by-wire system of a vehicle. The rotary actuator includes an electric motor; a plurality of electronic components, which are configured to control an operation of the electric motor; a control circuit board, to which the plurality of electronic components are installed; a position sensor, which is installed to the control circuit board; and a plurality of displacement limiting supports. The position sensor is configured to sense a rotational position of a rotor or a motor shaft of the electric motor. The plurality of displacement limiting supports support the control circuit board such that the plurality of displacement limiting supports limit displacement of the control circuit board. One or more of the plurality of displacement limiting supports are installed at a part or along an entire of a perimeter around the position sensor, and another one or more of the plurality of displacement limiting supports are installed at a part or along an entire of a perimeter around a corresponding one of the plurality of electronic components.

The displacement limiting supports support the control circuit board in the above-described manner, so that the displacement of the control circuit board can be limited even when an external input, such as a vibration, is applied to the control circuit board. By placing the displacement limiting support in the vicinity of the position sensor, a change in a gap between the magnet and the position sensor can be effectively limited. Therefore, it is possible to limit a deterioration in the sensing accuracy of the position sensor. Furthermore, the displacement of the control circuit board is further effectively limited by placing the displacement limiting support in the vicinity of a specific electronic component that has a relatively large weight among the plurality of electronic components. Therefore, it is possible to limit a deterioration in the durability of the electronic component or the solder placed at the control circuit board.

Hereinafter, a rotary actuator according to various embodiments of the present disclosure will be described with reference to the accompanying drawings. Portions, which are common among the embodiments, will be indicated by the same reference signs and will not be described redundantly.

### First Embodiment

The rotary actuator is used as a drive device of a shift-by-wire system of a vehicle.

### (Shift-by-Wire System)

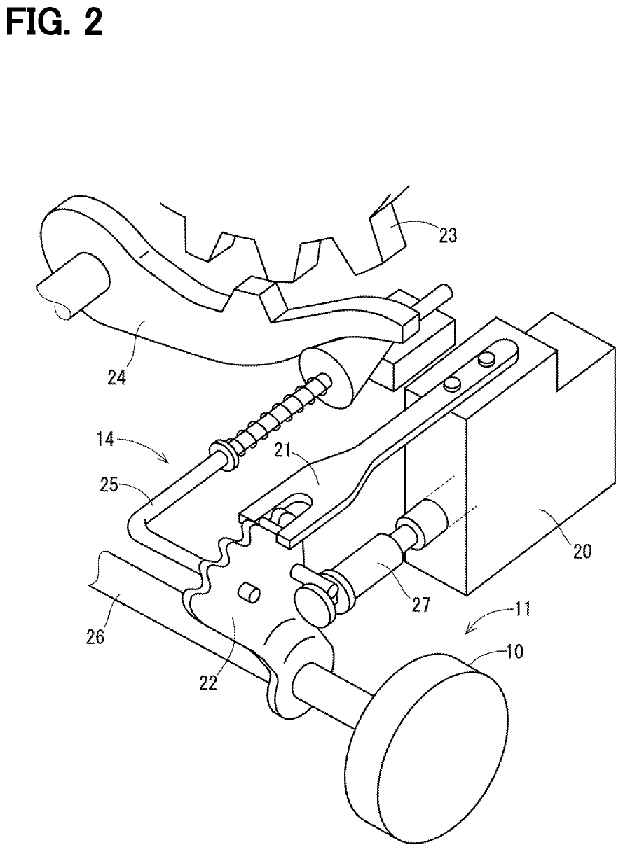

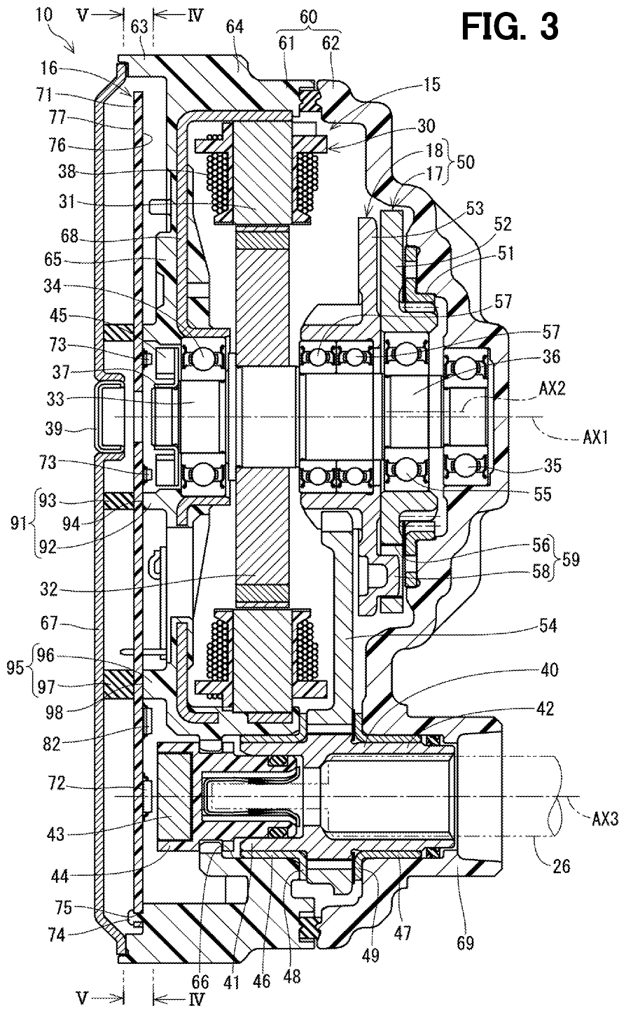

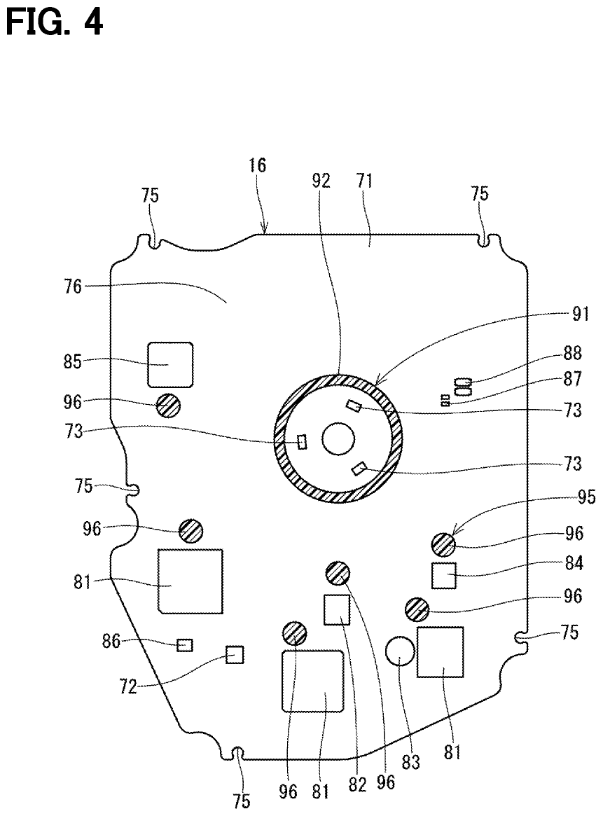

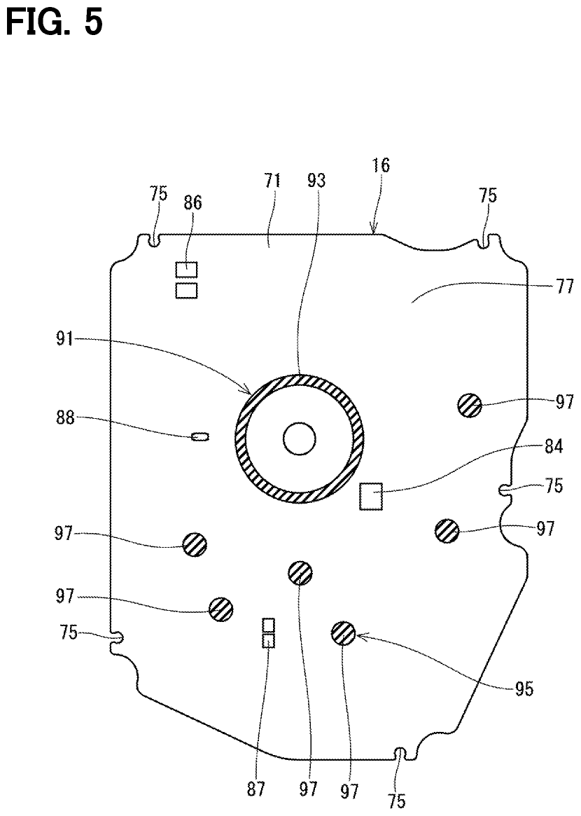

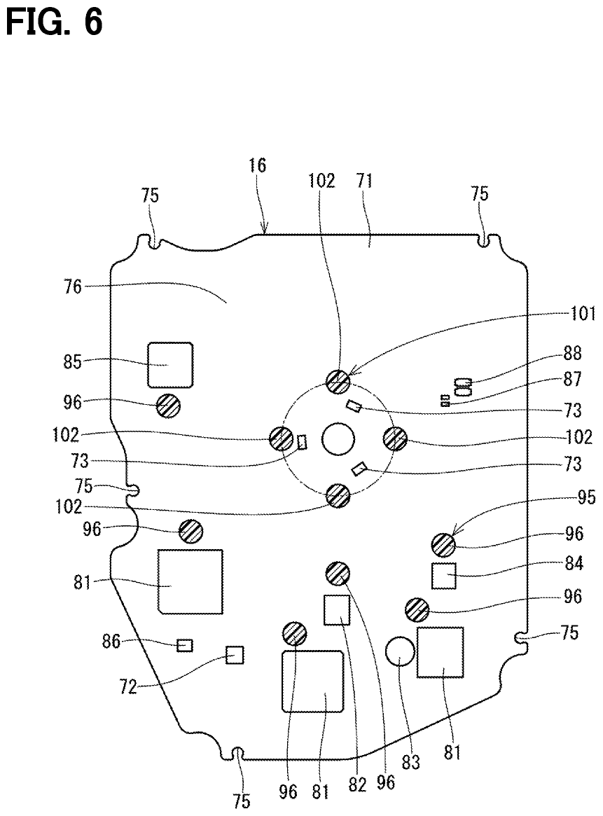

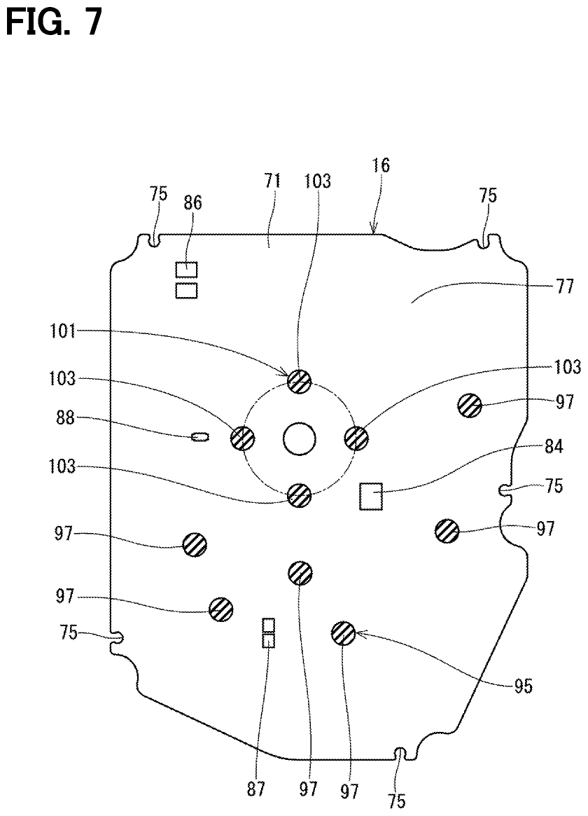

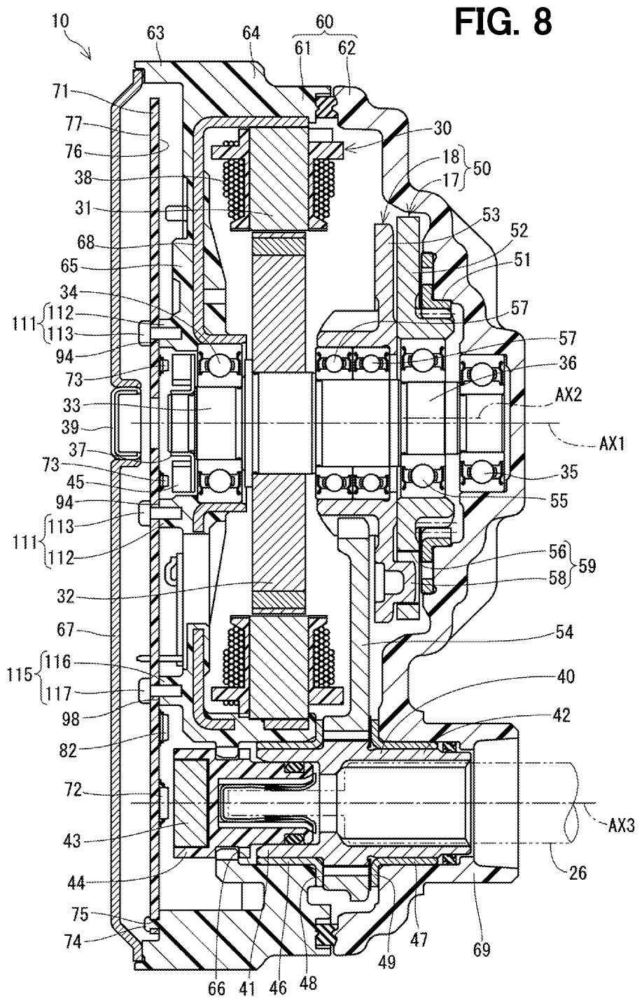

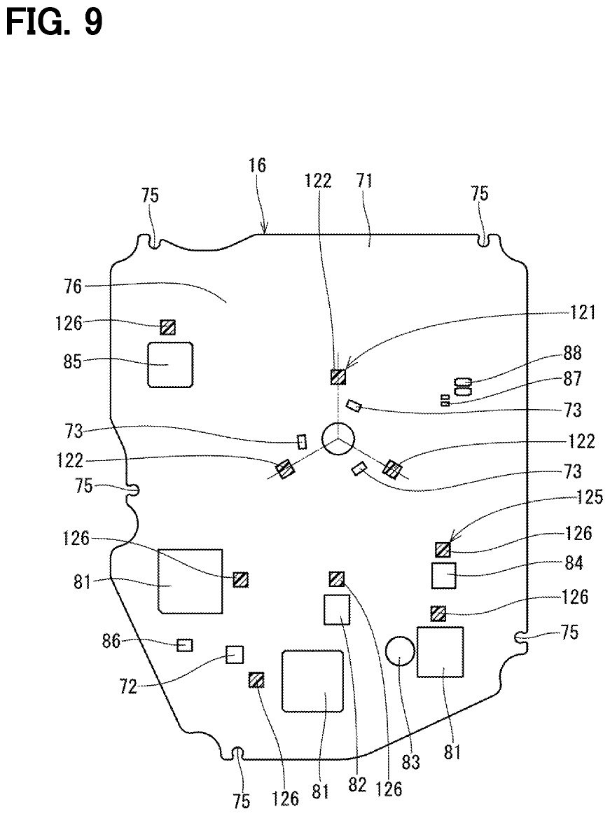

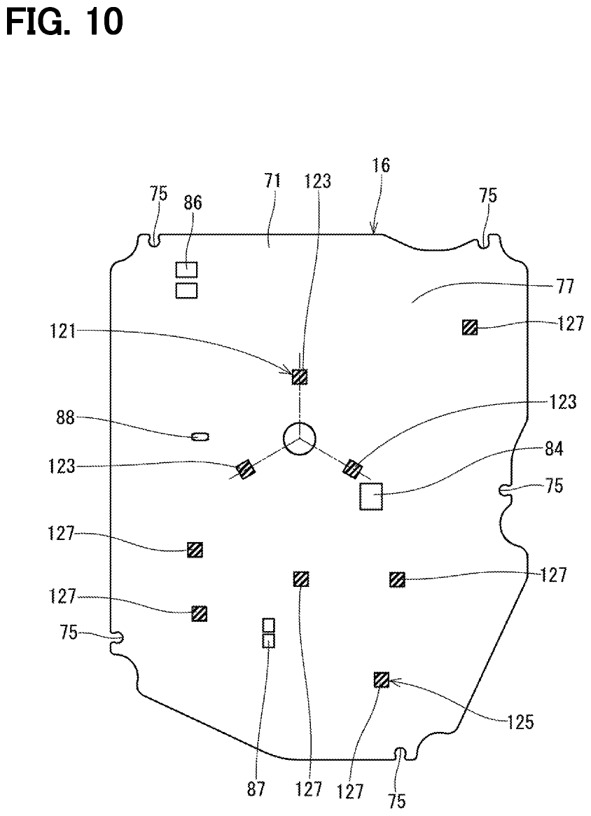

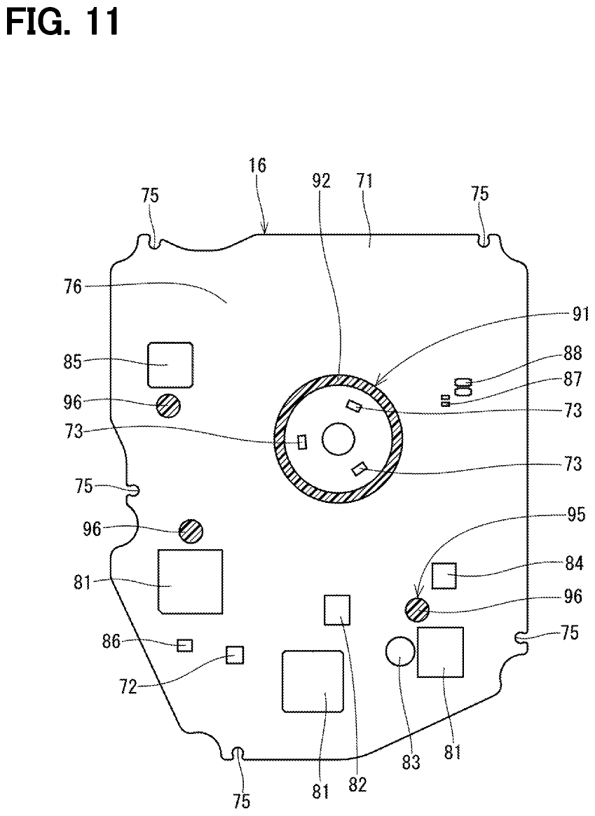

First of all, a structure of the shift-by-wire system will be described with reference to FIGS. 1 and 2. As shown in FIG. 1, the shift-by-wire system 11 includes: a shift manipulation device 13, which commands a shift range of a transmission 12; and a rotary actuator (hereinafter referred to as an actuator) 10, which drives a shift range change mechanism 14 of the transmission 12. The actuator 10 includes: a drive unit 15, which has an electric motor 30; and a control unit 16, which controls an operation of the electric motor 30 based on a command signal that is outputted from the shift manipulation device 13 and commands the shift range.

As shown in FIG. 2, the shift range change mechanism 14 includes: a range shift valve 20, which controls supply of an oil pressure to a hydraulic mechanism in the transmission 12 (see FIG. 1); a detent spring 21 and a detent lever 22, which cooperate together to hold a corresponding shift range; a park rod 25 that locks rotation of an output shaft of the transmission 12 by fitting a park pole 24 to a park gear 23 of the output shaft of the transmission 12 when the shift range is changed to a parking range; and a manual shaft 26, which is rotated integrally with the detent lever 22.

The shift range change mechanism 14 moves each of a valve element 27 of the range shift valve 20 and the park rod 25, which are coupled to the detent lever 22, to a corresponding position that corresponds to a target range by rotating the detent lever 22 along with the manual shaft 26. In the shift-by-wire system 11, the actuator 10 is connected to the manual shaft 26 to electrically change the shift range.

### (Actuator)

Next, the structure of the actuator 10 will be described. As shown in FIG. 3, the actuator 10 is an integrated electromechanical actuator that includes the drive unit 15 and the control unit 16 while the drive unit 15 and the control unit 16 are received in a case 60.

The case 60 includes an upper case segment 61, which is shaped in a tubular form, and a lower case segment 62, which is shaped in a cup form. The upper case segment 61 forms a partition wall 65 between one end portion 63 and the other end portion 64 of the upper case segment 61. A control circuit board 71 is installed at an inside of the one end portion 63. The control circuit board 71 is covered with a plate cover 67 that serves as a lid and is installed to an opening end of the one end portion 63, so that a required shielding performance for shielding the control circuit board 71 is ensured. The lower case segment 62 is assembled to the other end portion 64. The lower case segment 62 forms a tubular projection 69 that projects to an opposite side that is opposite from the upper case segment 61. The manual shaft 26 is placed such that the manual shaft 26 is inserted through the tubular projection 69.

The drive unit 15 includes: the electric motor 30, which serves as a drive source; an output shaft 40, which extends in parallel with a rotational axis AX1 of the electric motor 30; and a speed reducer mechanism 50, which reduces a speed of rotation outputted from the electric motor 30 and transmits the rotation of reduced speed to the output shaft 40.

The electric motor 30 includes: a stator 31, which is securely press fitted to a plate case 68 of the other end portion 64; a rotor 32, which is placed on a radially inner side of the stator 31; and a motor shaft 33 that is rotated together with the rotor 32 about the rotational axis AX1. The motor shaft 33 is rotatably supported by a bearing 34, which is installed to the plate case 68, and a bearing 35, which is installed to the lower case segment 62. Furthermore, the motor shaft 33 has an eccentric portion 36. The eccentric portion 36 is placed at the lower case segment 62 side of the rotor 32 and is eccentric to the rotational axis AX1. The electric motor 30 can be rotated in each of forward and backward directions and can be stopped at a desirable rotational position by controlling the supply of the electric current to three-phase windings 38 of the stator 31 through the control unit 16. A plug 39 is installed in a through-hole of the plate cover 67. In an event of a failure of the actuator 10, the plug 39 can be removed to enable manual rotation of the motor shaft 33.

The speed reducer mechanism 50 includes a first speed reducer 17 and a second speed reducer 18. The first speed reducer 17 includes a ring gear 51 and a sun gear 52. The second speed reducer 18 is a parallel axis type and includes a drive gear 53 and a driven gear 54 while a rotational axis of the drive gear 53 and a rotational axis of the driven gear 54 are parallel to each other. The ring gear 51 is placed about the rotational axis AX1. The sun gear 52 is rotatably supported by a bearing 55 fitted to the eccentric portion 36, so that the sun gear 52 is rotatable about an eccentric axis AX2 and is meshed with the ring gear 51 at the inside of the ring gear 51. When the motor shaft 33 is rotated, the sun gear 52 makes a planetary motion such that the sun gear 52 revolves about the rotational axis AX1 and rotates about the eccentric axis AX2. At this time, a rotational speed of the sun gear 52 is reduced relative to a rotational speed of the motor shaft 33. The sun gear 52 has a hole 56 for transmitting the rotation to the drive gear 53.

The drive gear 53 is placed along the rotational axis AX1 and is rotatably supported by a bearing 57, which is fitted to the motor shaft 33, such that the drive gear 53 rotates about the rotational axis AX1. The drive gear 53 has a projection 58, which is inserted into the hole 56 of the sun gear 52 to transmit the rotation between the sun gear 52 and the drive gear 53. The rotation of the sun gear 52 is transmitted to the drive gear 53 through the engagement between the hole 56 and the projection 58. The hole 56 and the projection 58 form a transmission mechanism 59. The driven gear 54 is placed along a rotational axis AX3, which is parallel with the rotational axis AX1 and is coaxial with the tubular projection 69, such that the driven gear 54 is meshed with the drive gear 53 at an outside of the drive gear 53. When the drive gear 53 is rotated about the rotational axis AX1, the driven gear 54 is rotated about the rotational axis AX3. The rotational speed of the driven gear 54 is reduced in comparison to the rotational speed of the drive gear 53.

The output shaft 40 is shaped in a tubular form and is placed about the rotational axis AX3. The partition wall 65 has a supporting through hole 66 that is coaxial with the rotational axis AX3. The output shaft 40 is supported by a first flanged bush 46, which is fitted into the supporting through hole 66, and a second flanged bush 47, which is fitted to the inside of the tubular projection 69, such that the output shaft 40 is rotatable about the rotational axis AX3. The driven gear 54 is a separate member formed separately from the output shaft 40 and is fitted to the output shaft 40 at an outside of the output shaft 40 such that the driven gear 54 is coupled to the output shaft 40 to transmit the rotation between the driven gear 54 and the output shaft 40. The manual shaft 26 is inserted into the inside of the output shaft 40 and is coupled to the output shaft 40 by, for example, spline fitting such that the output shaft 40 can transmit the rotation to the manual shaft 26.

One end portion 41 of the output shaft 40 is rotatably supported by the first flanged bush 46. The other end portion 42 of the output shaft 40 is rotatably supported by the second flanged bush 47. The driven gear 54 is axially supported by a first flange 48 of the first flanged bush 46 and a second flange 49 of the second flanged bush 47 while the driven gear 54 is held between the first flange 48 and the second flange 49. In another embodiment, the driven gear 54 may be axially supported by a pair of support portions, such as the case 60 and/or another plate.

The control unit 16 includes: a plurality of electronic components, which are configured to control the operation of the electric motor 30; the control circuit board 71, to which the electronic components are installed; an output shaft position sensor 72, which is installed to the control circuit board 71; and a plurality of motor position sensors 73, which are installed to the control circuit board 71. The control circuit board 71 has a plurality of outer peripheral fixing portions 75 that are placed at an outer periphery of the control circuit board 71 and are fixed to the partition wall 65 by heat swaging portions 74 through a heat swaging process that involves heat swaging of each of the heat swaging portions 74 against a corresponding one of the outer peripheral fixing portions 75. Specifically, in the heat swaging process, each heat swaging portion 74 formed integrally with the partition wall 65 in one piece is received in a recess of the corresponding outer peripheral fixing portion 75, and a tip of the heat swaging portion 74 is heated and is plastically deformed by a jig against a periphery of the recess of the corresponding outer peripheral fixing portion 75 to fix the circuit board 71 relative to the partition wall 65.

The electronic components include a plurality of microcomputers 81, a set of MOSFETs 82, a capacitor 83, a diode 84, an ASIC 85, an inductor 86, a resistor 87, a capacitor chip 88 and the like. The microcomputers 81 perform various calculations based on detection signals outputted from, for example, the output shaft position sensor 72 and the motor position sensors 73. The MOSFETs 82 perform a switching operation in response to a drive signal outputted from the microcomputer(s) 81 and switches energization of the three-phase windings 38. The capacitor 83 smoothens variations in the electric power inputted from a power source (not shown) and limits the outflow of noises generated due to the switching operation of the MOSFETs 82. Furthermore, the capacitor 83 cooperates with the inductor 86 to form a filter circuit. The ASIC 85 is an integrated circuit (IC) chip that executes a specific process at a high speed.

The output shaft position sensor 72 is placed at one (hereinafter referred to as one surface) 76 of two opposite surfaces of the control circuit board 71, which are opposite to each other in the axial direction of the rotational axis AX1, such that the output shaft position sensor 72 is opposed to a magnet 43. The magnet 43 is fixed to a holder 44 installed to the output shaft 40. The output shaft position sensor 72 senses the rotational position of the output shaft 40 and of the manual shaft 26, which are rotated together, by sensing a magnetic flux generated by the magnet 43.

The motor position sensors 73 are placed at the one surface 76 of the control circuit board 71 such that the motor position sensors 73 are opposed to a magnet 45. In the present embodiment, the number of the motor position sensors 73 is three, and these motor position sensors 73 are placed one after another in the circumferential direction about the rotational axis AX1. The magnet 45, which is in a ring form, is fixed to a holder 37 that is installed to the motor shaft 33. The motor position sensors 73 sense the rotational position of the motor shaft 33 and of the rotor 32 by sensing a magnetic flux generated from the magnet 45.

### (Control Unit)

Next, the control unit 16 and a structure around the control unit 16 will be described. As shown in FIGS. 3 to 5, the actuator 10 further includes a plurality of displacement limiting supports (serving as a plurality of urging displacement limiting supports) 91, 95.

The displacement limiting support 91 is installed along an entire of a perimeter around the motor position sensors 73 and supports the control circuit board 71 such that the displacement limiting support 91 limits positional displacement (hereinafter simply referred to as displacement) of the control circuit board 71. The expression of “installed along an entire of a perimeter” means “installed to entirely surround the subject(s).”

Specifically, the displacement limiting support 91 has a receiving portion 92, which contacts the one surface 76 of the control circuit board 71, and an urging portion 93, which urges the control circuit board 71 toward the receiving portion 92. In the present embodiment, the receiving portion 92 is a ring-shaped projection that projects from the partition wall 65 of the upper case segment 61 toward the control circuit board 71. The receiving portion 92 has a ring-shaped receiving surface 94 that makes a surface-to-surface contact with the one surface 76. The urging portion 93 is a ring-shaped elastic member made of, for example, rubber and is placed between the plate cover 67 and the other one (hereinafter referred to as the other surface) 77 of the two opposite surfaces of the control circuit board 71. The displacement limiting support 91 clamps the control circuit board 71 between the receiving portion 92 and the urging portion 93. A contact surface of the urging portion 93, which contacts the other surface 77, has a shape and a surface area, which are the same as a shape and a surface area of the receiving surface 94 of the receiving portion 92.

Each of the displacement limiting supports 95 is installed at a part of a perimeter around a corresponding specific component among the electronic components and supports the control circuit board 71 such that the displacement limiting support 95 limits the displacement of the control circuit board 71. Here, the specific component refers to a component having a relatively large weight among the electronic components. In the present embodiment, the specific components are the microcomputers 81, the MOSFETs 82, the capacitor 83, the diode 84 and the ASIC 85.

Specifically, each of the displacement limiting supports 95 has a receiving portion 96, which contacts the one surface 76 of the control circuit board 71, and an urging portion 97, which urges the control circuit board 71 toward the receiving portion 96. In the present embodiment, the receiving portion 96 is in a form of a columnar projection that projects from the partition wall 65 toward the control circuit board 71. The receiving portion 96 has a receiving surface 98 that makes a surface-to-surface contact with the one surface 76. The urging portion 97 is a columnar-shaped elastic member made of, for example, rubber and is placed between the plate cover 67 and the other surface 77. The displacement limiting support 95 clamps the control circuit board 71 between the receiving portion 96 and the urging portion 97. A contact surface of the urging portion 97, which contacts the other surface 77, has a shape and a surface area, which are the same as a shape and a surface area of the receiving surface 98 of the receiving portion 96.

### (Advantages)

As described above, according to the first embodiment, the actuator 10 includes the electric motor 30; the plurality of electronic components 81-88, which control the operation of the electric motor 30; the control circuit board 71, to which the plurality of electronic components 81-88 are installed; the motor position sensors 73, which are installed to the control circuit board 71; and the plurality of displacement limiting supports 91, 95. The motor position sensors 73 are configured to sense the rotational position of the rotor 32 and the motor shaft 33 of the electric motor 30. The displacement limiting support 91 is installed along the entire of the perimeter around the motor position sensors 73. Each of the displacement limiting supports 95 is installed at the part of the perimeter around the corresponding specific one of the electronic components 81-88. The displacement limiting supports 91, 95 support the control circuit board 71 such that the displacement limiting supports 91, 95 limit the displacement of the control circuit board 71.

The displacement limiting supports 91, 95 support the control circuit board 71 in the above-described manner, so that the displacement of the control circuit board 71 can be limited even when an external input, such as a vibration, is applied to the control circuit board 71. By placing the displacement limiting support 91 in the vicinity of the motor position sensors 73, a change in a gap (e.g., an axial gap) between the magnet 45 and the motor position sensors 73 can be effectively limited. Therefore, it is possible to limit a deterioration in the sensing accuracy of the motor position sensors 73. Furthermore, the displacement of the control circuit board 71 is further effectively limited by placing each displacement limiting support 95 in the vicinity of the corresponding specific electronic component that has the relatively large weight. Therefore, it is possible to limit a deterioration in the durability of the electronic components 81-88 and/or the solder placed at the control circuit board 71.

Furthermore, in the present embodiment, the displacement limiting support 91 has the receiving portion 92, which contacts the one surface 76 of the control circuit board 71, and the urging portion 93, which urges the control circuit board 71 toward the support portion 92. Each of the displacement limiting supports 95 also has the receiving portion 96 and the urging portion 97, which are similar to the receiving portion 92 and the urging portion 93 of the displacement limiting support 91. Therefore, the displacement of the control circuit board 71 can be limited by the urging load exerted from the urging portions 93, 97.

Furthermore, in the present embodiment, the actuator 10 includes the case 60, which rotatably supports the motor shaft 33, and the plate cover 67, which serves as the lid for the control circuit board 71. The displacement limiting supports 91, 95 clamp the control circuit board 71 between the receiving portions 92, 96, which are formed at the upper case segment 61 of the case 60, and the urging portions 93, 97, which are placed at the plate cover 67. The displacement of the control circuit board 71 can be effectively limited by reliably urging the control circuit board 71 against the receiving surfaces 94, 98 by the urging load of the urging portions 93, 97.

Furthermore, in the present embodiment, each of the urging portions 93, 97 is the elastic member. Therefore, the urging load can be easily generated by the urging portions 93, 97.

### Second Embodiment

In the second embodiment, as shown in FIGS. 6 and 7, a plurality of displacement limiting supports (serving as a plurality of urging displacement limiting supports) 101 are respectively installed at a plurality of discrete parts of the perimeter around the motor position sensors 73. In the present embodiment, the plurality of displacement limiting supports 101 are arranged one after the other at equal intervals in the circumferential direction to surround the motor position sensors 73. A receiving portion 102 of each of the displacement limiting supports 101 is in a form of a columnar projection. An urging portion 103 of each displacement limiting support 101 is an elastic member that is shaped in a columnar form. The displacement limiting supports 101 clamp the control circuit board 71 between the receiving portions 102 and the urging portions 103. A contact surface of the urging portion 103, which contacts the other surface 77, has a shape and a surface area, which are the same as a shape and a surface area of a receiving surface of the receiving portion 102.

The displacement limiting supports 101 support the control circuit board 71, so that the advantages, which are similar to those of the first embodiment, can be achieved. Furthermore, the displacement limiting support(s) 101 may be installed only at a section of the perimeter around the motor position sensors 73. In other words, it is not necessary to circumferentially arrange the displacement limiting supports 101 at equal intervals, and the number of the displacement limiting support(s) 101 is not necessary limited to four and may be one, two, three or more than four.

### Third Embodiment

In the third embodiment, as shown in FIG. 8, a plurality of displacement limiting supports (serving as a plurality of fixing displacement limiting supports) 111 are respectively installed at a plurality of discrete parts of the perimeter around the motor position sensors 73. In the present embodiment, the plurality of displacement limiting supports 111 are arranged one after the other at equal intervals in the circumferential direction to surround the motor position sensors 73. Furthermore, each of the displacement limiting supports 111 has a receiving portion 112, which contacts the one surface 76 of the control circuit board 71, and a fixing portion 113, which fixes the control circuit board 71 to the receiving portion 112. In the present embodiment, each of the fixing portions 113 is a screw (i.e., a fastening member).

Each of a plurality of displacement limiting supports (serving as a plurality of fixing displacement limiting supports) 115 is installed at a part of a perimeter around a corresponding specific one of the electronic components 81-88. Each of the displacement limiting supports 115 has a receiving portion 116, which contacts the one surface 76 of the control circuit board 71, and a fixing portion 117, which fixes the control circuit board 71 to the receiving portion 116. In the present embodiment, each of the fixing portions 117 is a screw (i.e., a fastening member).

As described above, the displacement limiting supports 111, 115 support the control circuit board 71, so that advantages, which are similar to those of the first embodiment, can be achieved. Furthermore, each of the displacement limiting supports 111, 115 has the receiving portion 112, 116 and the fixing portion 113, 117. In this way, the fixing portions 113, 117 are installed to the control circuit board 71 in a common installation direction, and thereby the assembling operation can be simplified.

### Other Embodiments

In another embodiment, as shown in FIGS. 9 and 10, a shape of a cross-section of each of the receiving portion 122, 126 and the urging portion 123, 127 of the displacement limiting supports (serving as a plurality of urging displacement limiting supports) 121, 125 is not necessarily a circular form and may be in a rectangular form. Furthermore, the shape of the cross-section of the receiving portion 122, 126 and the shape of the cross-section of the urging portion 123, 127 may be in another form, such as a polygonal form or an arcuate form. Furthermore, the number of the displacement limiting supports 121, which are arranged one after the other along the perimeter of the motor position sensors 73, may be three. Alternatively, the number of the displacement limiting supports 121 may be two or less or five or more.

In another embodiment, the displacement limiting supports are not necessarily placed in the vicinity of all of the electronic components 81-85, each of which has the relatively large weight. For example, as shown in FIG. 11, the displacement limiting support 95 may be placed in the vicinity of one or more of the electronic components 81-85.

In another embodiment, in each of the displacement limiting supports, the shape and/or the surface area of the contact surface of the urging portion, which contacts the other surface of the control circuit board, are not be necessarily the same as the shape and/or the surface area of the receiving surface of the receiving portion. Specifically, as long as the contact surface of the urging portion and the receiving surface of the receiving portion respectively have the clamping areas that clamp the control circuit board therebetween, the shape and/or the surface area of the contact surface of the urging portion may differ from the shape and/or the surface area of the receiving surface of the receiving portion. For example, the receiving portion 92 of the first embodiment shown in FIG. 4 and the urging portions 103 of the second embodiment shown in FIG. 7 may be combined to support the control circuit board 71.

In another embodiment, the displacement limiting support(s), which has the urging portion, and the displacement limiting support(s), which has the fixing portion, may be both provided to support the control circuit board.

In another embodiment, the urging portion of each displacement limiting support is not necessarily made of the rubber and may be an elastomer made of another material that is other than the rubber. Furthermore, the urging portion may be a spring, such as a coil spring or a flat spring. In short, the urging portion only needs to have a material and a shape that implement a spring property.

In another embodiment, the fixing portion of each displacement limiting support is not necessarily the screw and may be another type of fastening member, such as a rivet. Furthermore, the fixing portion may be: one of a fastening member, a bonding agent, a welding portion, a swaging portion (e.g., a heat swaging portion also known as a heat staking portion), a press-fixing portion and a press-fitting portion; or a combination of any two or more of the fastening member, the bonding agent, the welding portion, the swaging portion, the press-fixing portion and the press-fitting portion.

The present disclosure should not be limited to the embodiments described above and may be implemented in various other forms without departing from the spirit of the present disclosure.

What is claimed is:

1. A rotary actuator for a shift-by-wire system of a vehicle, the rotary actuator comprising:
an electric motor;
a plurality of electronic components, which are configured to control an operation of the electric motor;
a control circuit board, to which the plurality of electronic components are installed;
a position sensor, which is installed to the control circuit board and is configured to sense a rotational position of a rotor or a motor shaft of the electric motor; and
a plurality of displacement limiting supports that support the control circuit board such that the plurality of displacement limiting supports limit displacement of the control circuit board, wherein one or more of the plurality of displacement limiting supports are installed at a part or along an entire of a perimeter around the position sensor, and another one or more of the plurality of displacement limiting supports are installed at a part or along an entire of a perimeter around a corresponding one of the plurality of electronic components.

2. The rotary actuator according to claim 1, wherein the plurality of displacement limiting supports include at least one urging displacement limiting support that has a receiving portion, which contacts one of two opposite surfaces of the control circuit board, and an urging portion, which urges the control circuit board toward the support portion.

3. The rotary actuator according to claim 1, wherein the plurality of displacement limiting supports include at least one fixing displacement limiting support that has a receiving portion, which contacts one of two opposite surfaces of the control circuit board, and a fixing portion, which fixes the control circuit board to the receiving portion of the at least one fixing displacement limiting support.

4. The rotary actuator according to claim 2, comprising a case, which rotatably supports the motor shaft, and a cover, which serves as a lid for the control circuit board, wherein:
the at least one urging displacement limiting support clamps the control circuit board between the receiving portion, which is formed at the case, and the urging portion, which is placed at the cover.

5. The rotary actuator according to claim 2, wherein the urging portion is an elastic member.

6. The rotary actuator according to claim 3, wherein the fixing portion is:
one of a fastening member, a bonding agent, a welding portion, a swaging portion, a press-fixing portion and a press-fitting portion; or
a combination of any two or more of the fastening member, the bonding agent,
the welding portion, the swaging portion, the press-fixing portion and the press-fitting portion.
